(19) United States
(12) Patent Application Publication
(10) Pub. No.: US 2005/0200756 A1
(43) Pub. Date: Sep. 15, 2005

(54) Image photographing apparatus

(75) Inventors: Cheul-Hae Park, Suwon-si (KR); Chan-Seob Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/059,562

(22) Filed: Feb. 17, 2005

(30) Foreign Application Priority Data
Mar. 10, 2004 (KR) 2004-16085

(51) Int. Cl. H04N 5/225

(52) U.S. Cl. 348/376

(57) ABSTRACT

An image photographing apparatus such as a camcorder has an improved structure for opening and closing a housing door of a deck unit. A tape cassette is mounted to the deck unit from the front to the rear side of the apparatus, and substantially vertically with respect to the deck unit. Accordingly, compact-sized image photographing apparatus can be provided.

This application claims the benefit under 35 U.S.C. § 119(a) of Korean Patent Application No. 2004-16085, entitled “Image Photographing Apparatus,” filed Mar. 10, 2004, the entire contents of which are hereby incorporated by reference.

### BACKGROUND OF THE INVENTION

1. Field of the Invention

The present invention relates to a portable image photographing apparatus, such as a camcorder, capable of storing and reproducing images. More particularly, an image photographing apparatus having a housing door positionable about a vertical axis for conserving space and allowing rearrangement of the mounting and dismounting path of an image recording medium.

2. Description of the Related Art

Recently, portable image photographing apparatuses have been widely used mainly due to their convenience. The portable image photographing apparatuses are used in a variety of events, including hobby and leisure activities. Thanks to the advancements of digital technology, digital cameras and camcorders are now rapidly replacing analog ones.

Generally, a camcorder incorporates therein the function of a tape recorder and a camera. The camcorder is able to record, reproduce and edit image information as desired by the operator. The camcorder is mainly classified into two categories, hand-held types and shoulder-types. The shoulder-type camcorders are expensive and are generally for professional use. The hand-held type camcorders are compact and light-weight, and are wide spread, especially for personal use.

The hand-held camcorder, usually compact and portable, is also classified into two categories, a shooting-type and a vertical-type, according to the exterior structure of the camcorder. The shooting-type camcorder resembles a gun shape. The exterior structure of the camcorder has a horizontal length that is longer than the vertical length. In contrast, the vertical-type camcorder has an exterior structure in which the vertical length is longer than the horizontal length.

Meanwhile, in a general conventional hand-held camcorder, a deck unit (not shown) is mounted inside an outer casing of the camcorder body 120 where the camera unit 110 is integrally formed. An exterior structure is formed such that a housing door 140 is opened and closed, irrespective of the type of the model, in a vertical direction about a horizontal axis for the mounting and dismounting of a tape cassette (not shown) with respect to the deck unit (not shown).

Accordingly, a variety of associated equipment structures are required for the realization of the opening and closing structure of the housing door mentioned above, and therefore space, especially in a lateral direction, is necessary. As a result, realization of compact products in the future is limited. Moreoever, another drawaback is that when the housing door is opened and closed in the downward direction, the cassette tape may tilt downward during the operation of the product, and therefore, stability is affected.

### SUMMARY OF THE INVENTION

Accordingly, the present invention has been made to solve the above-mentioned problems occurring in the related art, and an object of the present invention is to provide a convenient, compact, and stable image photographing apparatus.

The foregoing and other objects are substantially realized by providing an image photographing apparatus comprising a body having a deck for recording and reproducing image information inputted through a camera unit, and a PCB (printed circuit board) mounted therein. A housing door is movably mounted on a side of the body to allow loading and unloading of a tape cassette with respect to the deck. The housing door may is hingedly opened and closed proximate the front side of the body. An ocular lens is mounted on one end of the body, and a objective lens is mounted on the other end of the body. The tape cassette is loaded from an objective lens end toward an ocular lens end of the camera unit. Alternatively, upon being mounted in the deck, the tape cassette is ejected from the ocular lens end toward the objective lens end of the camera unit.

In the image photographing apparatus constructed according to one aspect of the present invention, the tape cassette may be loaded in the deck in the front direction, and disposed substantially vertical with respect to the body.

The deck unit may oriented substantially vertical so that a head drum is located near the ocular lens end of the camera unit.

Other objects, advantages, and salient features of the invention will become apparent from the detailed description, which, taken in conjunction with the annexed drawings, discloses preferred embodiments of the invention.

### BRIEF DESCRIPTION OF THE DRAWINGS

The above aspects and features and advantages of certain embodiments of the present invention will become more apparent from the following detailed description taken in reference to the accompanying drawings, in which:

FIG. 1 is a perspective view of a general conventional image photographing apparatus;

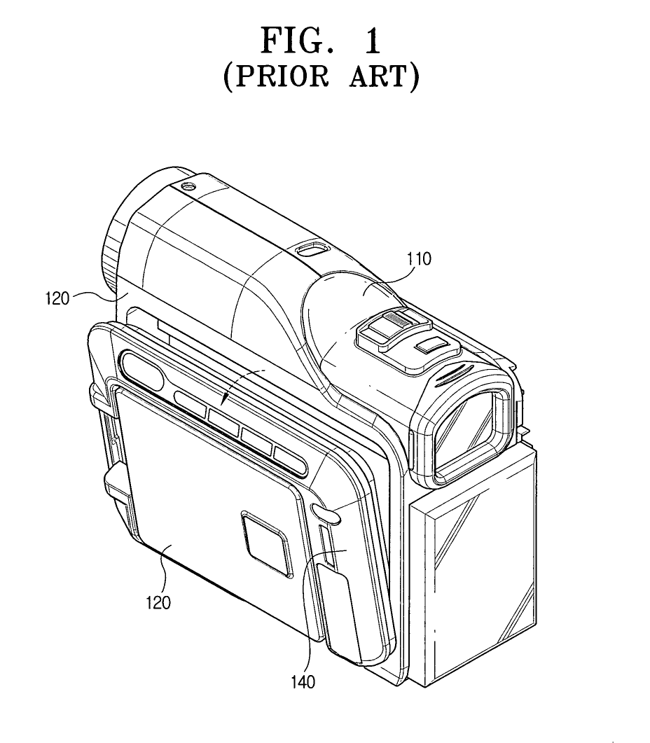

FIG. 2 is a plan view illustrating the outer structure of an image photographing apparatus according to an embodiment of the present invention; and

FIG. 3 is a perspective view of a housing door of the image photographing apparatus of FIG. 2.

Throughout the drawings, the same drawing reference numerals will be understood to refer to refer to the same elements, features, and structures.

### DETAILED DESCRIPTION OF EXEMPLARY EMBODIMENTS

The matters defined in the description such as a detailed construction and elements thereof, are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions are omitted for conciseness.

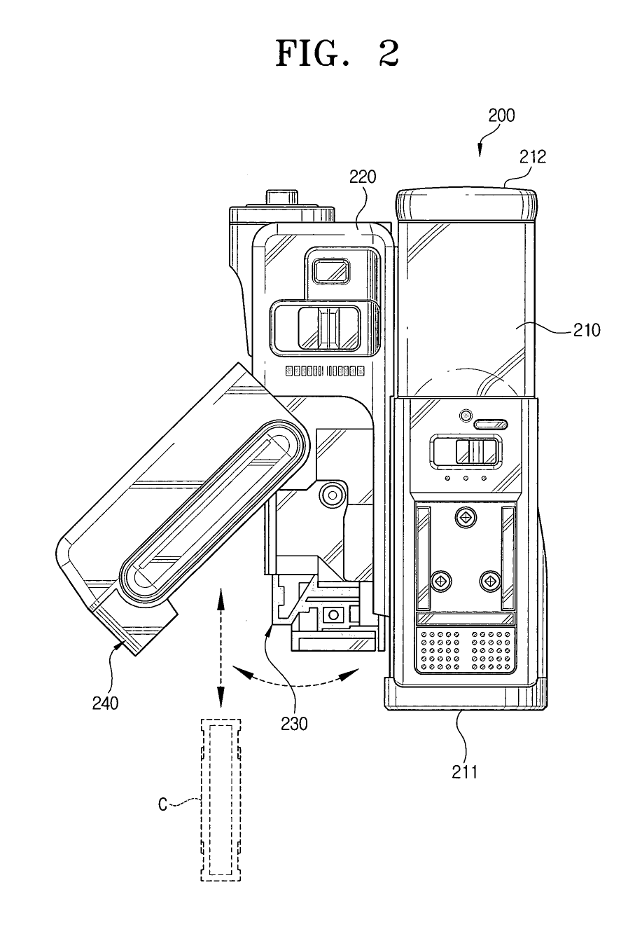

Referring to FIG. 2, an image photographing apparatus 200 according to an embodiment of the present invention comprises a body 220 having a deck unit 230 for driving a recording medium such as a magnetic tape for the recording and reproduction of image information of an object captured through a camera unit 210 having a PCB (printed circuit board) mounted therein. A housing door 240 movably engaged to a side of the body 220 to hinge open and close for loading and unloading of the tape cassette (C).

In the image photographing apparatus 200 as described above, the housing door 240 is opened to the front of the body 220. The tape cassette (C) is loaded toward an end of the body where the ocular lens 212 from end of the body where the objective lens 211 is positioned. Alternatively, the tape cassette (C) is ejected toward the end of the body 220 having the objective lens 211 from the ocular lens 212.

The deck unit 230, although not illustrated in drawings in detail, is mounted in a substantially vertical direction so that a head drum for scanning on the magnetic tape, is located proximate the ocular lens 212. For example, the general direction of mounting the deck unit 230 in a tape recorder is such that, the head drum is arranged to face an upper or lower portion of the deck unit 230. The hingedly connected housing door 240 rotates between open and closed positions about a vertical axis. In such a general image photographing apparatus 200, the deck unit 230 generally has a horizontal arrangement. However, in the present embodiment, the deck unit 230 is formed approximately at 90° left or right from the horizontal axis of of the product.

Accordingly, a tape cassette, being arranged in a vertical relation with respect to the body 220, is loaded and unloaded to the front of the deck unit 230 through the housing door 240.

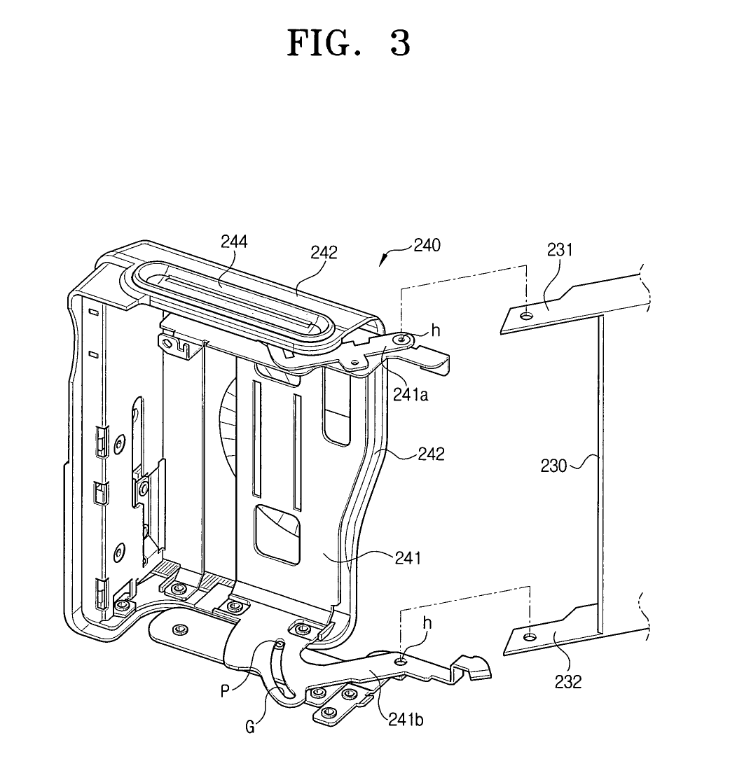

Referring to FIG. 3, the housing door 240 comprises a housing frame 241 preferably formed of metal frames by molding. The housing door 240 engages with the deck unit 230 for hingedly rotating. A door frame 242, preferably formed by injection molding engages with the housing frame 241 by a plurality of screws (S) covering the housing frame 241, thus forming a part of the exterior of the outer casing of the body 220.

The housing frame 241 comprises a pair of links 241a and 241b. The pair of links 241a and 241b are engaged with a pair of hinge frames 231 and 232 protruding from both ends of the deck unit 230, constructing a hinge structure (h). The reference character G denotes a guide opening for restricting the hinge movement of the housing frame 241 and the door frame 242, and the reference character P denotes a guide pin engaged in the guide opening (G). A groove 244 is also provided to open the housing door 240.

With the forward-open housing door structure of an image photographing apparatus as described above in accordance with one embodiment of the present invention, a tape cassette is loaded and unloaded with respect to the deck unit 230 through the forwardly openable housing door, along a plane substantially orthogonal with respect to the deck unit 230. As a result, the overall length of the product set in lateral direction is reduced, and a a compact image photographing apparatus having a unique exterior structure may be provided.

As described above in a few exemplary embodiments of the present invention, the improved structure for opening and closing a housing door with respect to the deck unit allows a cassette of an image recording medium to be loaded and unloaded with respect to the deck unit from the front to the rear side of the image photographing apparatus, at a substantially orthogonaly position with respect to a plane of the deck unit. Consquently, the size of the exterior structure, especially the lateral length of the image photographing apparatus can be reduced, and a compact image photographing apparatus is provided, which is convenient to use and adjust.

While the invention has been shown and described with reference to certain embodiments thereof, it will be understood by those skilled in the art that various changes in form and details may be made therein without departing from the spirit and scope of the invention as defined by the appended claims.

1. An image photographing apparatus, comprising:
a body having a deck unit for recording/reproducing of image information inputted through a camera unit, and a printed circuit board mounted therein; the body being configured to have an ocular lens mounted on one end thereof, and an objective lens mounted on the other end thereof, and
a housing door movably mounted on a side of the body to allow loading and unloading of a tape cassette with respect to the deck unit, wherein
the housing door is hingedly opened and closed proximate the front side of the body,
the tape cassette is loaded from the objective lens toward an ocular lens of the body, and upon being mounted in the deck unit, the tape cassette is ejected from the ocular lens toward the objective lens of the body.

2. The image photographing apparatus of claim 1, wherein the tape cassette is forwardly loaded in the deck unit, and substantially vertically with respect to the body.

3. The image photographing apparatus of claim 1, wherein the deck unit is oriented substantially vertical so that a head drum is located near the ocular lens of the camera unit.

4. The image photographing apparatus of claim 1, wherein
the housing door further comprises a plurality of links for engaging a plurality of hinge frames of the deck unit for connecting the housing door to the deck unit.

5. The image photographing apparatus of claim 4, wherein
the housing door further comprises a door frame and a housing frame.

6. The image photographing apparatus of claim 4, wherein
the housing door has a guide opening, and a guide pin engageable with the guide opening for limiting movement of the housing frame.

7. The image photographing apparatus of claim 4, wherein
the housing door has a guide opening, and a guide pin egangeable with the guide opening for limiting movement of the door frame.
